(19) United States
(12) Patent Application Publication
(10) Pub. No.: US 2026/0066328 A1
(43) Pub. Date: Mar. 5, 2026

(54) RECHARGEABLE LITHIUM-ION MICRO-BATTERY AND METHODS OF MAKING AND USING THE SAME

(71) Applicant: Battelle Memorial Institute, Richland, WA (US)

(72) Inventors: Zhiqun Deng, Richland, WA (US); Jie Xiao, Richland, WA (US); Bingbin Wu, Richland, WA (US); Dianying Liu, Richland, WA (US); Jun Lu, Richland, WA (US)

(73) Assignee: Battelle Memorial Institute, Richland, WA (US)

(21) Appl. No.: 18/816,962

(22) Filed: Aug. 27, 2024

(51) Int. Cl. H01M 10/04; H01M 4/38; H01M 4/525; H01M 4/587; H01M 10/0525; H01M 50/107; H01M 50/609

(52) U.S. Cl. CPC H01M 10/0431; H01M 4/382; H01M 4/386; H01M 4/525; H01M 4/587; H01M 10/0436; H01M 10/049; H01M 10/0525; H01M 50/107; H01M 50/609

(57) ABSTRACT

A cylindrical battery having a wound jelly roll configuration that includes an anode current collector having a first surface and an opposing second surface; at least one anode disposed on the first surface of the anode current collector; at least one Li metal film disposed on the first surface anode current collector, wherein the at least one Li metal film is spaced apart from the anode; a cathode current collector having a first surface and an opposing second surface; at least one cathode disposed on the first surface of the cathode current collector; and a first membrane separator positioned between the anode and the cathode.

### BACKGROUND

Batteries play a critical role in determining the lifetime of downsized sensors, wearable devices, medical devices, and animal acoustic telemetry transmitters. There are and will continue to be demands for batteries which provide continuous rechargeable capability on a smaller scale for use in the electrical devices including to provide operational energy to microelectronics. Current winding technology in cylindrical lithium-ion batteries has limited capability to produce a micro-battery having a height of less than 4 mm due to the overhang issue. An example of current winding technology is shown in FIG. 1. The overhang is the gap distance between an edge of an electrode sheet (e.g., an anode) and an edge of a separator sheet or another electrode sheet (e.g., a cathode). The gap can be lengthwise and/or widthwise. Normally, the size of the separator sheet is larger than the anode electrode sheet, and the anode electrode sheet is larger than the cathode electrode sheet. The overhang of separator sheet and anode sheet is designed to avoid direct contact of the cathode electrode sheet and the anode electrode sheet that would result in a short. The overhang of the anode electrode sheet and the cathode electrode sheet is designed to avoid Li metal deposition outside of the anode electrode that would result in capacity decay and a safety issue. An example of the overhang is shown in FIG. 2.

The overhang control in current lithium-ion battery technology is at least 0.5 mm for separator/anode and 0.5 mm for anode/cathode. If the distance is smaller than 0.5 mm, it is difficult to properly align the electrodes during the winding process resulting in a very high risk for a short or Li metal deposition.

In one example with a battery height of 4 mm:
Separator width=battery height-can thickness (bottom) and top seal structure=4 mm -1 mm=3 mm; 3.5 mm wide separator will be used considering that the separator can be pressed.
Anode width=separator width-2*overhang=3.5 mm-1 mm=2.5 mm;
Cathode width=anode width-2*overhang=2.5 mm-1 mm=1.5 mm.

However, if the micro-battery height is less than 3 mm, the width of the cathode electrode sheet will be close to 0 mm to maintain the overhang; therefore, manufacturing a rechargeable micro-battery with a height of less than 4 mm by current winding technology is very difficult.

### SUMMARY

Disclosed herein is a cylindrical battery having a wound jelly roll configuration comprising:
an anode current collector having a first surface and an opposing second surface;
at least one anode disposed on the first surface of the anode current collector;
at least one Li metal film disposed on the first surface anode current collector, wherein the at least one Li metal film is spaced apart from the anode;
a cathode current collector having a first surface and an opposing second surface;
at least one cathode disposed on the first surface of the cathode current collector; and
a first membrane separator positioned between the anode and the cathode.

Also disclosed herein is an electrochemical cell comprising:
an anode current collector having a first surface and an opposing second surface;
an anode material disposed on the first surface of the anode current collector;
a Li metal film disposed on the first surface anode current collector, wherein the Li metal film is spaced apart from the anode;
a cathode current collector having a first surface and an opposing second surface;
a cathode material disposed on the first surface of the cathode current collector;
a first membrane separator positioned between the anode and the cathode;
a second membrane separator positioned facing the second surface of the anode current collector;
a third current collector that is an additional anode current collector or an additional cathode current collector;
and a tab protruding from the anode current collector or from the cathode current collector,
wherein the tab protruding from the anode current collector or from the cathode current collector is the only protruding tab provided in the electrochemical cell.

Further disclosed herein is a process for making a cylindrical battery comprising:
stacking sequentially a first membrane separator; an anode current collector having disposed thereon an anode electrode sheet material and a Li metal film, wherein the Li metal film is spaced apart from the anode electrode sheet material; a second membrane separator; and a cathode current collector having disposed thereon a cathode electrode sheet material;
winding the resulting stack into a cylindrical jelly roll;
attaching a third current collector to the cylindrical jelly roll;
inserting the cylindrical jelly roll into a hollow cylinder casing; and
introducing a liquid electrolyte into the hollow cylinder casing.

The foregoing will become more apparent from the following detailed description, which proceeds with reference to the accompanying figures.

### BRIEF DESCRIPTION OF THE DRAWINGS

FIG. 1 depicts an example of a prior art cylindrical battery stack structure and winding method.

FIG. 2 depicts an example of a prior art overhang arrangement.

FIG. 3 depicts an example of an inventive anode/separator/cathode arrangement as disclosed herein.

FIGS. 4A-4C depict examples of several placements of a Li metal film along a longitudinal direction of an inventive anode/separator/cathode arrangement as disclosed herein.

FIG. 5 depicts an example of wound jelly roll configuration of an inventive anode/separator/cathode arrangement as disclosed herein.

FIG. 6 depicts a comparison of an overhang between the prior art and the inventive arrangement.

FIG. 7 depicts an example of an inventive anode/separator/cathode arrangement as disclosed herein (single side-coated cathode and anode electrodes).

FIG. 8 are photographs showing a process for making an inventive battery as disclosed herein.

FIG. 9 are graphs showing the performance of an inventive battery as disclosed herein.

FIG. 10 are graphs showing the performance of an inventive battery as disclosed herein.

### DETAILED DESCRIPTION

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about”is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:
Anode: An electrode through which electric charge flows into a polarized electrical device. From an electrochemical point of view, negatively-charged anions move toward the anode and/or positively-charged cations move away from it to balance the electrons leaving via external circuitry. In a discharging battery or galvanic cell, the anode is the negative terminal where electrons flow out. If the anode is composed of a metal, electrons that it gives up to the external circuit are accompanied by metal cations moving away from the electrode and into the electrolyte. When the battery is recharged, the anode becomes the positive terminal where electrons flow in and metal cations are reduced. Unless otherwise specified, the term “anode” as used herein, refers to the negative electrode or terminal where electrons flow out during discharge.
Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized. Unless otherwise specified, the term “cathode”as used herein, refers to the positive electrode during discharge.
Cell: As used herein, a cell refers to an electrochemical device used for generating a voltage or current from a chemical reaction, or the reverse in which a chemical reaction is induced by a current. A battery includes one or more cells. The terms “cell” and “battery” are used interchangeably when referring to a battery containing only one cell.
Membrane separator: A porous membrane placed between the anode and cathode. It prevents physical contact between the anode and cathode while facilitating ionic transport.

### Overview

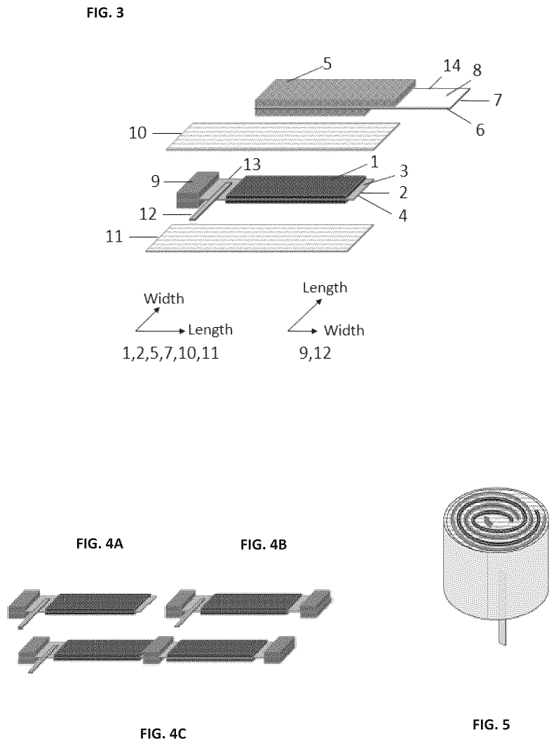

Disclosed herein is a cylindrical rechargeable micro-battery made from a wound jelly roll configuration that includes an anode electrode sheet, a membrane separator sheet and a cathode electrode sheet. An illustrative example of a battery arrangement as disclosed herein is shown in FIGS. 3-7.

The anode electrode sheet material is disposed on an anode current collector. A Li metal film is also disposed on the anode current collector proximate to, but not contacting, the anode material. The Li metal film acts as a lithium source in the battery. When an electrolyte contacts the Li metal film and the anode electrode sheet concurrently, Li⁺ ions automatically ionized from the Li metal film will travel through the electrolyte and contact the anode electrode material and undergo reduction. In certain examples, the amount of Li metal film is designed to achieve an a fully-lithiated anode (e.g., LiC₆ when the anode material is graphite). The cathode electrode sheet material is disposed on a cathode current collector. The cathode electrode sheet active material is a lithium-free material or a pre-charged delithiated material.

The Li metal-attached anode current collector sheet/membrane separator sheet/cathode current collector sheet sandwich is wound into a cylindrical jelly roll. The jelly roll is inserted into a hollow cylinder casing (e.g., Al, stainless steel or Ti) and a liquid electrolyte is also introduced into the cylinder casing. The battery is sealed, and metal contacts are attached.

This configuration enables downsizing of rechargeable micro-battery height. For example, the height of the micro-battery can be 3 mm or less, more particularly 2 mm or less, even more particularly 1.7 mm or less. The micro-battery diameter can be 5 mm or less, more particularly 3 mm or less, even more particularly 1.8 mm or less.

The overhang issue is not present in the electrode configuration disclosed herein.

### Embodiments

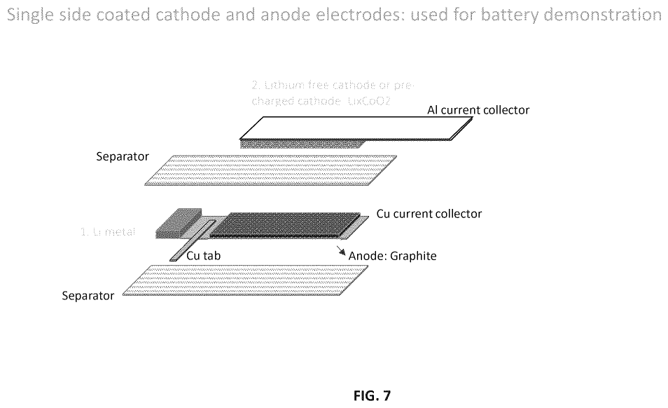

As shown in FIGS. 3-7, an anode electrode sheet material 1 is disposed on a first surface 3 of an anode current collector 2. In certain embodiments, the anode electrode sheet material 1 is also disposed on an opposing surface 4 of the anode current collector 2 (see FIG. 3). In certain embodiments, the anode electrode sheet material 1 is disposed on only the first surface 3 of the anode current collector 2 (see FIG. 7).

In certain embodiments, the anode current collector has a thickness of 1 μm to 30 μm, more particularly 8 μm to 10 μm. In certain embodiments, the anode has a thickness of 15 μm to 300 μm, more particularly 20 μm to 60 μm. In certain embodiments, each individual anode has a length of 2 mm to 50 mm, more particularly 5 mm to 15 mm.

A cathode electrode sheet material 5 is disposed on a first surface 6 of a cathode current collector 7. The cathode current collector also has an opposing surface 8 that faces the outside of the anode/cathode cell assembly. In certain embodiments, the cathode electrode sheet material 5 is also disposed on an opposing surface 8 of the cathode current collector 7 (see FIG. 3). In certain embodiments, the cathode electrode sheet material 5 is disposed on only the first surface 6 of the cathode current collector 7 (see FIG. 7).

In certain embodiments, the cathode current collector has a thickness of 5 μm to 30 μm, more particularly 10 μm to 15 μm. In certain embodiments, the cathode has a thickness of 20 μm to 300 μm, more particularly 30 μm to 100 μm. In certain embodiments, each individual cathode has a length of 1 mm to 50 mm, more particularly 3 mm to 12 mm.

The anode current collector and the cathode current collector may be made from any electrically conductive material. In certain embodiments, the cathode current collector is Al, and the anode current collector is Cu.

A Li metal film 9 is disposed on the first surface 3 of the anode current collector 2 proximate to, but not contacting, the anode 1. In certain embodiments, the Li metal film 9 is also disposed on the opposing surface 4 of the anode current collector 2 (see FIG. 3). In certain embodiments, the Li metal film 9 is disposed on only the first surface 3 of the anode current collector 2 (see FIG. 7). The Li metal film is pure Li. In certain embodiments, the distance 13 from the proximate edge of the Li metal film to the proximate edge of the anode is 0.5 mm to 3 mm, more particularly 1 mm to 2 mm.

The Li metal film acts as a lithium source in the battery. When an electrolyte contacts the Li metal film and the anode sheet material concurrently, Li⁺ ions automatically ionized from the Li metal film will dissolve and travel through the electrolyte and contact the anode electrode material, resulting in fully lithiated the anode electrode material. Electrons in the Li metal film travel to the anode material via the anode current collector. The Li⁺ ion and the electrons react with the anode active material causing reduction of the anode active material. For example, when the anode material is graphite the anode reduction reaction is C₆+e⁻+Li⁺→LiC₆. The Li metal film is consumed after the reduction reaction ends.

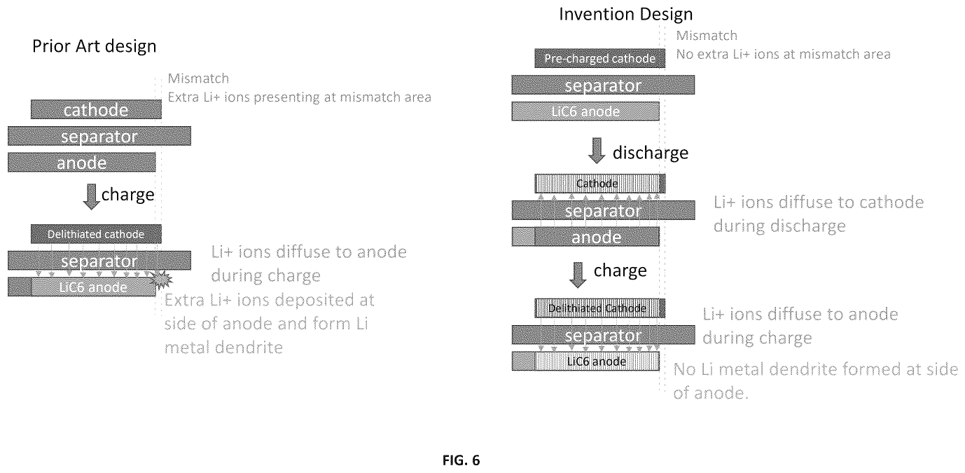

The number and position of the Li metal film(s) relative to the anode electrode may vary with the diameter of the battery relating to the length of the anode electrode, ensuring the fast dynamic of the Li metal traveling to the anode. Several examples are shown in FIGS. 4A-4C. In FIG. 4A there is a single Li metal film 9 per a single anode electrode 1. In FIG. 4B there are two Li metal films 9 per a single anode electrode 1, FIG. 4C shows an embodiment in which a plurality of anode electrodes 1 are aligned and spaced longitudinally along the anode current collector with a Li metal film 9 located between each anode electrode. In one aspect, Li metal films can also be located at each end of a current collector with an anode electrode located between the Li metal films. In certain examples, up to ten Li metal films can be located on a single current collector strip.

In certain examples, the length of the Li metal film is the same as the width of the anode current collector. In certain embodiments, the length of the Li metal film is 0.5 mm to 10 mm, more particularly 1 mm to 3 mm. The width of each individual Li metal film may be from 0.5 mm to 5 mm, more particularly 1 to 2 mm. In certain examples, the Li metal film has a thickness of 5 to 300 μm, more particularly 20 to 100 μm.

Even if a misalignment of the anode electrode and the cathode electrode occurs during the winding process, or the size of the anode electrode is smaller than cathode electrode, no Li metal deposition occurs. Without the overhang issue, cathode electrodes and anode electrodes of the same size can be utilized to produce shorter rechargeable micro-battery. In an example, a novel design disclosed herein allows for producing short rechargeable micro-batteries down to a height of 1.6 mm.

The micro-battery also includes at least one membrane separator. In certain embodiments, there is a membrane separator disposed between the anode and the cathode. In the embodiment shown in FIG. 3, there is a first membrane separator 10 disposed between the anode sheet material 1 and the cathode sheet material 5. In FIG. 3 a second membrane separator 11 is adjacent to the second surface 4 of the first current collector 2. The second membrane separator 11 is disposed between, and separates, the anode and cathode in the wound jelly roll configuration (see FIG. 5). In certain embodiments, the membrane separator has a thickness of 5 μm to 50 μm, more particularly 10 μm to 20 μm. Illustrative membrane separator materials include polypropylene, polyethylene, polypropylene/polyethylene/polypropylene block copolymer, ceramic-coated polypropylene, ceramic-coated polyethylene, and a nonwoven fabric.

In certain embodiments, each anode/cathode cell includes a third current collector. The third current collector may be an extra current collector for the anode or an extra current collector for the cathode. In the embodiment shown in FIG. 3, a third current collector 12 is located at the center of the distance 13 from the proximate edge of the Li metal film to the proximate edge of the anode. In one aspect, the third current collector can wrap the jellyroll configuration and physically attach to the inside wall of the battery casing. In certain embodiments, the third current collector can be an extra Al current collector 14 or an extra Cu current collector depending on the material of the battery casing. Both Al current collectors and Cu current collectors can be used with battery casing materials such as stainless steel and Ti.

In certain embodiments, the anode, the cathode, and the current collectors all have the same width. In certain embodiments, the anode has a width of 0.5 mm to 10 mm, more particularly 1 mm to 3 mm. In certain embodiments, the cathode has a width of 0.5 mm to 10 mm, more particularly 1 mm to 3 mm. In certain embodiments, the membrane separator has a width of 1 mm to 10.5 mm, more particularly 1.5 mm to 3.5 mm. In certain embodiments, the current collector has a width of 0.5 mm to 10 mm, more particularly 1 mm to 3 mm.

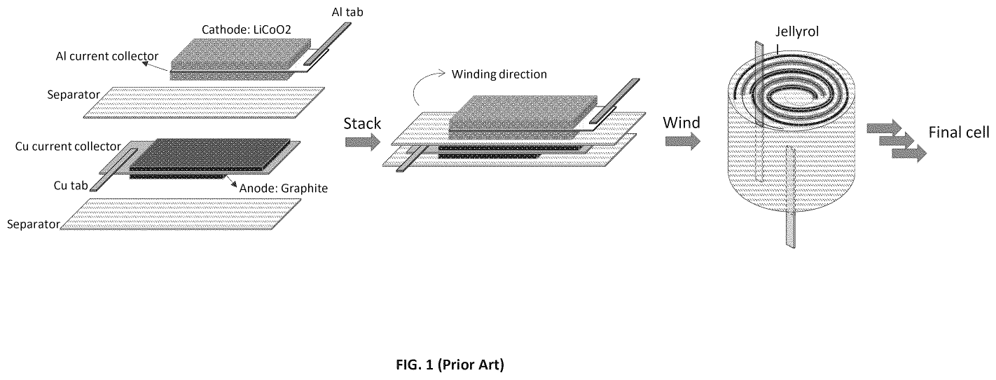

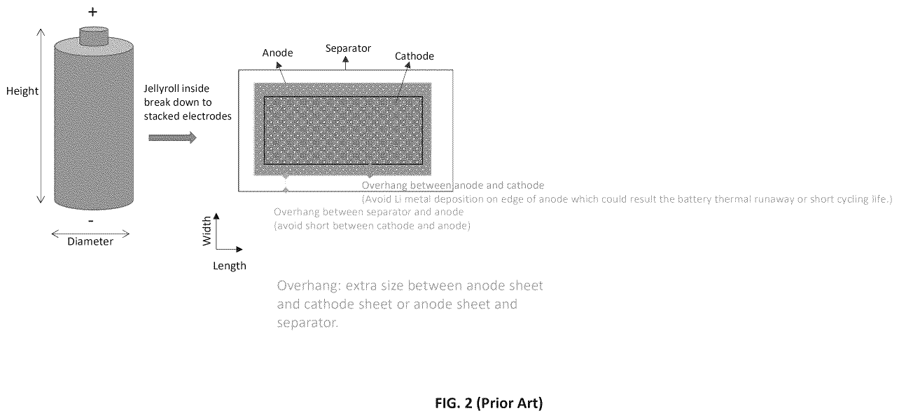

In certain embodiments, the Li metal-attached anode current collector/separator sheet/cathode current collector sandwich also includes only one electrical connection protruding tab that is in contact with, and extends beyond an edge, one of the current collectors. Prior art embodiments include two electrical connection protruding tabs for each anode/cathode cell (see FIG. 1). The electrical connection protruding tab may be made from the same material as the current collector. In certain embodiments, the electrical connection protruding tab may be positioned on the anode current collector between the Li metal film and the anode material, but does not contact the Li metal film or the anode material. In certain examples, the electrical connection tab may have a length of 3 mm to 20 mm, a width of 0.2 mm to 2 mm, and a thickness of 0.03 mm to 0.2 mm. With the combination of a third current collector replacing a second electrical connection protruding tab, the internal stress of the jellyroll configuration will be reduced due to the absence of one electrical connection protruding tab compared to prior art configurations, particularly for micro-batteries with a diameter less than or equal to 3 mm. If the micro-battery diameter is greater than 3 mm, then double electrical connection protruding tabs or multiple electrical connection protruding tabs can be utilized as in conventional lithium-ion batteries.

The anode includes an active material. Illustrative anode active materials include graphite, hard carbon, soft carbon, Si, SiOₓ (0<x≤2), and graphite/SiOₓ mixtures. In certain examples, the anode active material is graphite. In certain examples, the active material is Si.

The cathode includes an active material. The cathode active material can be a lithium-free material or a pre-charged delithiated material. Illustrative lithium-free materials include sulfur, MnO₂, FeS, MoS₂ and mixtures thereof. A pre-charged delithiated material can be obtained by utilizing conventional cathode materials, electrochemically coupling these materials with Li metal, and assembling the electrochemical coupled material/Li metal into a battery (e.g., coin cell or a single layer pouch cell). The resulting battery is charged to a high cut off voltage (3-5 V) to achieve delithiated cathode material, and then the battery is disassembled to harvest the resulting delithiated cathode electrode. The harvested delithiated cathode material is cut into a required size for assembling into the rechargeable micro-battery disclosed herein. Illustrative conventional cathode materials include LiCoO₂, LiNiₓMn_{y}Co_{z}O₂ (x>0.2, x+y+z=1), LiMn₂O₄, LiNi_{0.5}Mn_{1.5}O₄, and LiFePO₄. The cut off charge varies depending on the material (4.2-4.5V for LiCoO₂, LiNiMnCoO₂, LiMn₂O₄, 4.6-5.0V for LiNi_{0.5}Mn_{1.5}O₄, 3.6-4.0V for LiFePO₄). The resulting pre-charged delithiated materials include LiₓCoO₂ (x<=0.5), LiₓNiMnCoO₂ (x<=0.5), LiₓMn₂O₄ (x<=0.5), LiₓNi_{0.5}Mn_{1.5}O₄ (x<=0.5), and LiₓFePO₄ (x<=0.5). In certain embodiments, the cathode composition can include conductive carbon and/or a binder.

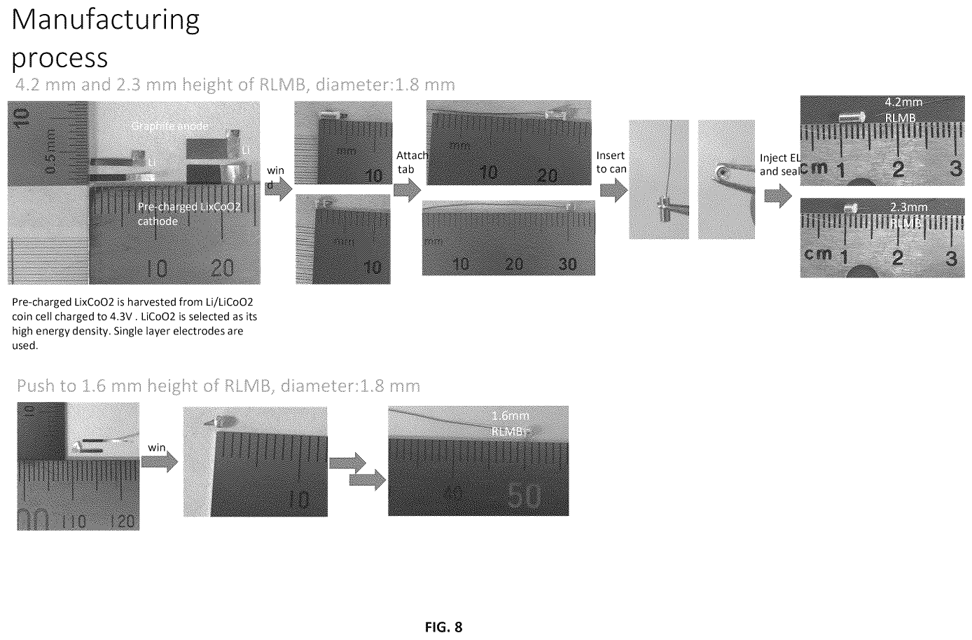

FIG. 8 shows a general process for making an inventive micro-battery. The main process includes: 1) Prepare the pre-charged LiₓCoO₂ cathode electrode sheet and Li metal film attached graphite anode electrode sheet with required size. Three different sizes are displayed in FIG. 8, including 0.5 mm, 1 mm, and 3 mm wide cathode/anode electrode sheets for rechargeable MB1816, MB1823, and MB1842 batteries respectively. 2) Stack membrane separator sheet, Li metal-attached anode electrode sheet, membrane separator sheet and cathode electrode sheet in sequence and the stacked sheets are wound into a cylindrical jelly roll. An additional current collector (e.g., an Al current collector) is the last layer of the winding. The additional Al current collector is an extension of the cathode current collector, but without cathode material deposed on it, to wrap the complete jelly roll after winding ends and contact the internal wall of the housing can after the jelly roll is inserted into the housing can, thus acting as positive terminal of the battery.

A piece of green tape is applied to wrap the jelly roll. 3) The third current collector, i.e., a Cu wire, is attached to the Cu current collector sheet as electrical connection protruding tab. This tab is the negative terminal of as-made micro battery. 4) The jelly roll is inserted into a hollow Al cylinder casing and a liquid electrolyte is also introduced into the cylinder casing by vacuum injection. The green tape is required to be removed prior to inserting jelly roll into the Al cylinder casing so that the extra Al current collector outside of the jelly roll can contact the Al cylinder casing, acting as positive terminal of as-made micro battery. 5) The battery is finally sealed with epoxy adhesive and cured in 24 hours. All the processes are performed in a dry room (dew point: −51° C.).

The resulting sandwich is rolled up and inserted into a hollow cylinder casing, wherein the casing provides electrically isolated electrical connections to the anode and to the cathode. A liquid electrolyte is introduced into the casing that includes the jelly roll. In general, the electrolyte includes at least one active salt and at least one solvent. Illustrative electrolyte active materials include lithium salts. Illustrative lithium salts include lithium bis(fluorosulfonyl)imide (LiN(SO₂F)₂, LiFSI), lithium bis(trifluoromethanesulfonyl)imide (LiN(SO₂CF₃)₂, LiTFSI), lithium bis(pentafluoroethanesulfonyl)imide (LiN(SO₂C₂F₅)₂, LiBETI), lithium bis(oxalato)borate (LiBOB), LiPO₂F₂, LiPF₆, LiAsF₆, LiBF₄, CF₃SO₃Li, LiClO₄, lithium difluoro(oxalato)borate (LiDFOB), LiI, LiBr, LiCl, LiSCN, LiNO₃, LiNO₂, Li₂SO₄, or a mixture thereof. Illustrative solvents include carbonates and/or ethers. Illustrative solvents include ethylene carbonate (EC), dimethyl carbonate (DMC), vinylene carbonate (VC), fluoroethylene carbonate (FEC), difluoroethylene carbonate (DFEC), trifluoroethylene carbonate (TFEC), vinyl ethylene carbonate (VEC), 4-methylene ethylene carbonate (MEC), propylene carbonate (PC), ethyl methyl carbonate (EMC), diethyl carbonate (DEC), methyl 2,2,2-trifluoroethyl carbonate (MFEC), dimethoxyethane (DME), 1,3-dioxolane (DOL), tetrahydrofuran (THF), allyl ether, 1,1,2,2-tetrafluoroethyl-2,2,3,3-tetrafluoropropyl ether (TTE), or a mixture thereof. Exemplary additives include, but are not limited to, fluoroethylene carbonate (FEC), difluoroethylene carbonate (DFEC), or a combination thereof; vinylene carbonate (VC), vinyl ethylene carbonate (VEC), 4-methylene ethylene carbonate (MEC), 4,5-dimethylene ethylene carbonate (DMEC), tris(trimethylsilyl)phosphite (TTMSPi), N-(trimethylsilyl)diethylamine (TMSDEA), 1,3-propane sultone (PS), 1,3,2-dioxathiolane 2,2-dioxide (DTD, 1,2-ethylene sulfate), LiFSI, LiNO₃, or a mixture thereof. In certain embodiments, the salt concentration is 0.5 M to 10 M, more particularly 1 M. In certain embodiments, the additive concentration is 0.1 to 10 wt %, based on the weight of the electrolyte composition.

The cylindrical battery is sealed, and metal contacts are attached. In certain embodiments, the separator sheet, anode electrode sheet, separator sheet and cathode electrode sheet are sequentially disposed radially from center of the cylindrical battery to the housing can. The winding end portion is the third current collector which is an extra Al current collector 14. The winding start portion is the separator sheets 10, 11 close to the Li metal film 9. Winding direction is the clockwise direction from the start portion (FIG. 3 and FIG. 7).

### EXAMPLES

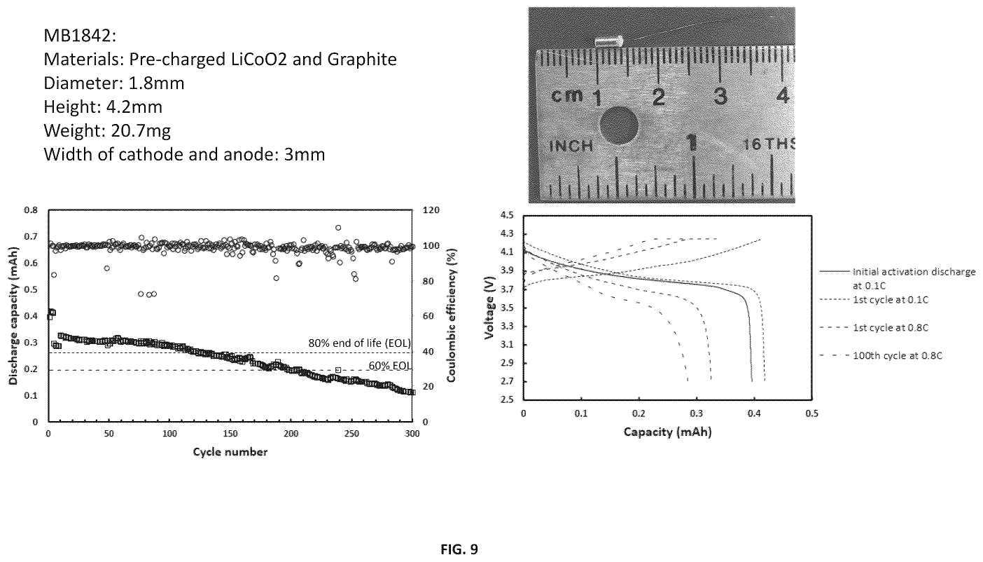

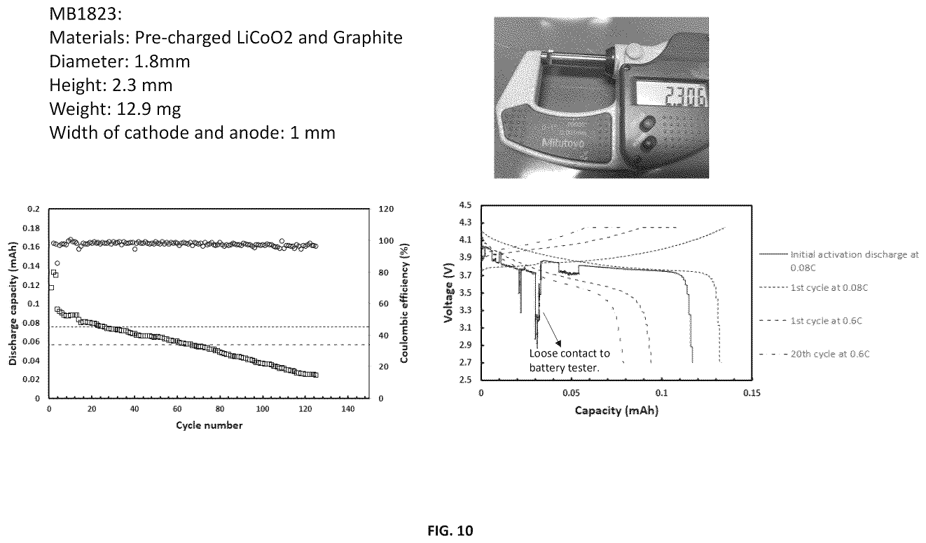

Testing protocol of the rechargeable micro battery: The capacity, voltage profile and cycling performance of the micro batteries were assessed on a Landt battery tester (CT2001A) at 25° C. in a battery testing chamber. Formation: 1) Discharge the battery to 2.7 V with 0.1 C (FIG. 9, MB1842, 1 C=0.4 mA) or 0.08 C (FIG. 10, MB1823, 1 C=0.13 mA). 2) Charge the battery to 4.25 V with 0.1 C (MB1842) or 0.08 C (MB1823) then discharge to 2.7 V. 3) Repeat step (2) for 3 times. Cycling: 1) Charge at 0.8 C (MB1842) or 0.6 C (MB1823) to 4.25 V and then perform the constant voltage charge at 4.25 V until the current rate drops to 0.1 C. 2) Discharge at 0.8 C (MB1842) or 0.6 C (MB1823) to 2.7 V. 3) Repeat the step 1) and 2) until the capacity reaches 10-30% of EOL (end-of-life).

Rechargeable MB1842 demonstrated a capacity of 0.41 mAh at 0.1 C and 130 cycles at 80% EOL at 0.8 C as shown in FIG. 9. The coulombic efficiency of the battery is >99%.

Rechargeable MB1823 demonstrated a capacity of 0.13 mAh at 0.08 C and 30 cycles at 80% EOL at 0.6 C as shown in FIG. 10. The coulombic efficiency of the battery is >99%.

In view of the many possible embodiments to which the principles of the disclosed invention may be applied, it should be recognized that the illustrated embodiments are only preferred examples of the invention and should not be taken as limiting the scope of the invention.

What is claimed is:

1. A cylindrical battery having a wound jelly roll configuration comprising:
an anode current collector having a first surface and an opposing second surface;
at least one anode disposed on the first surface of the anode current collector;
at least one Li metal film disposed on the first surface anode current collector, wherein the at least one Li metal film is spaced apart from the anode;
a cathode current collector having a first surface and an opposing second surface;
at least one cathode disposed on the first surface of the cathode current collector; and
a first membrane separator positioned between the anode and the cathode.

2. The battery of claim 1, wherein the battery has a height of 3 mm or less.

3. The battery of claim 1, wherein the battery has a height of 2 mm or less.

4. The battery of claim 1, wherein the battery has a height of 1.7 mm or less.

5. The battery of claim 1, wherein the battery has a diameter of 5 mm or less.

6. The battery of claim 2, wherein the battery has a diameter of 3 mm or less.

7. The battery of claim 3, wherein the battery has a diameter of 1.8 mm or less.

8. The battery of claim 1, further comprising a second membrane separator positioned facing the second surface of the anode current collector.

9. The battery of claim 1, wherein the anode is also disposed on the second surface of the anode current collector.

10. The battery of claim 1, further comprising a third current collector that is an additional anode current collector or an additional cathode current collector.

11. The battery of claim 10, further comprising an electrical connection tab protruding from the anode current collector or from the cathode current collector, wherein the electrical connection tab protruding from the anode current collector or from the cathode current collector is the only electrical connection protruding tab provided in the battery.

12. The battery of claim 1, wherein the Li metal film has a width of 0.5 mm to 5 mm.

13. The battery of claim 1, wherein the Li metal film has a thickness of 5 μm to 300 μm.

14. The battery of claim 2, wherein the Li metal film has a thickness of 5 μm to 300 μm.

15. The battery of claim 1, wherein the distance from the proximate edge of the Li metal film to the proximate edge of the anode is 0.5 mm to 3 mm.

16. The battery of claim 1, wherein the battery includes a plurality of Li metal films.

17. The battery of claim 1, wherein the battery includes a plurality of anodes aligned and spaced longitudinally along the anode current collector with an individual Li metal film located between each anode.

18. The battery of claim 1, wherein the anode comprises graphite, hard carbon, soft carbon, Si, SiOₓ (0<x≤2), or a graphite/SiOₓ (0<x≤2).

19. The battery of claim 1, wherein the anode comprises graphite.

20. The battery of claim 1, wherein the cathode comprises a lithium-free material or a pre-charged delithiated material.

21. The battery of claim 20, wherein the lithium-free material comprises sulfur, MnO₂, FeS, MoS₂ or a mixture thereof.

22. The battery of claim 20, wherein the pre-charged delithiated material comprises LiₓCoO₂ (x<=0.5), LiₓNiMnCoO₂ (x<=0.5), LiₓMn₂O₄ (x<=0.5), LiₓNi_{0.5}Mn_{1.5}O₄ (x<=0.5), or LiₓFePO₄ (x<=0.5).

23. The battery of claim 20, wherein the pre-charged delithiated material comprises LiₓCoO₂ (x<=0.5).

24. The battery of claim 6, further comprising a second membrane separator positioned facing the second surface of the anode current collector; a third current collector that is an additional anode current collector or an additional cathode current collector; and an electrical connection tab protruding from the anode current collector or from the cathode current collector, wherein the electrical connection tab protruding from the anode current collector or from the cathode current collector is the only protruding tab provided in the battery.

25. The battery of claim 24, wherein the anode comprises graphite, and the cathode comprises a pre-charged delithiated material comprising LiₓCoO₂ (x<=0.5).

26. An electrochemical cell comprising:
an anode current collector having a first surface and an opposing second surface;
an anode material disposed on the first surface of the anode current collector;
a Li metal film disposed on the first surface anode current collector, wherein the Li metal film is spaced apart from the anode;
a cathode current collector having a first surface and an opposing second surface;
a cathode material disposed on the first surface of the cathode current collector;
a first membrane separator positioned between the anode and the cathode;
a second membrane separator positioned facing the second surface of the anode current collector;
a third current collector that is an additional anode current collector or an additional cathode current collector;
and a tab protruding from the anode current collector or from the cathode current collector,
wherein the tab protruding from the anode current collector or from the cathode current collector is the only protruding tab provided in the electrochemical cell.

27. The electrochemical cell of claim 26, wherein the cathode current collector comprises Al, the anode current collector comprises Cu, the anode comprises graphite or silicon, the cathode comprises a lithium-free material or a pre-charged delithiated material, the Li metal film has a width of 0.5 mm to 5 mm and a has a thickness of 5 to 300 μm, and the distance from the proximate edge of the Li metal film to the proximate edge of the anode is 0.5 mm to 3 mm.

28. A process for making a cylindrical battery comprising:
stacking sequentially a first membrane separator; an anode current collector having disposed thereon an anode electrode sheet material and a Li metal film, wherein the Li metal film is spaced apart from the anode electrode sheet material; a second membrane separator; and
a cathode current collector having disposed thereon a cathode electrode sheet material;
winding the resulting stack into a cylindrical jelly roll;
attaching a third current collector to the cylindrical jelly roll;
inserting the cylindrical jelly roll into a hollow cylinder casing; and
introducing a liquid electrolyte into the hollow cylinder casing.
